(19) United States
(12) Patent Application Publication
(10) Pub. No.: US 2016/0087516 A1
(43) Pub. Date: Mar. 24, 2016

(54) LINEAR-ROTARY ACTUATOR

(71) Applicant: KABUSHIKI KAISHA YASKAWA DENKI, Kitakyushu-shi (JP)

(72) Inventors: Shogo MAKINO, Kitakyushu-shi (JP); Motomichi OHTO, Kitakyushu-shi (JP)

(73) Assignee: KABUSHIKI KAISHA YASKAWA DENKI, Kitakyushu-shi (JP)

(21) Appl. No.: 14/856,566

(22) Filed: Sep. 17, 2015

(30) Foreign Application Priority Data
Sep. 18, 2014 (JP) 2014-190584

(51) Int. Cl. H02K 41/03; H02K 1/12; H02K 1/27

(52) U.S. Cl. CPC H02K 41/031; H02K 1/2706; H02K 1/12

(57) ABSTRACT

A linear-rotary actuator includes a rotor and a stator. The rotor includes an output shaft, and makes a linear motion in an axial direction and a rotary motion in a circumferential direction. The rotor includes N and S pole portions alternating with each other in the axial direction as seen in the circumferential direction and alternating with each other in the circumferential direction as seen in the axial direction. The stator includes a linear motion winding, a rotary motion winding, and protruding cores. The protruding cores protrude toward an inner circumferential side of a radial direction to be opposed to the rotor. The protruding cores are arranged in the axial direction and in the circumferential direction, and displaced in the axial direction to form a circumferential line skewed relative to a direction in which the rotor makes the rotary motion.

### CROSS-REFERENCE TO RELATED APPLICATIONS

The present application claims priority under 35 U.S.C. §119 to Japanese Patent Application No. 2014-190584, filed Sep. 18, 2014. The contents of this application are incorporated herein by reference in their entirety.

### BACKGROUND

1. Field of the Invention

The embodiments disclosed herein relate to a linear-rotary actuator.

2. Discussion of the Background

Japanese Unexamined Patent Application Publication No. 2004-343903 discloses a linear-rotary actuator that makes linear and rotary motions.

### SUMMARY

According to one aspect of the present disclosure, a linear-rotary actuator includes a rotor and a stator. The rotor includes an output shaft, and is configured to make a linear motion in an axial direction of the output shaft and make a rotary motion in a circumferential direction of the output shaft. The rotor includes N pole portions and S pole portions alternating with each other in the axial direction as seen in the circumferential direction and alternating with each other in the circumferential direction as seen in the axial direction. The stator includes a linear motion winding, a rotary motion winding, and a plurality of protruding cores. The linear motion winding generates a first magnetic field to cause the rotor to make the linear motion. The rotary motion winding generates a second magnetic field to cause the rotor to make the rotary motion. The plurality of protruding cores protrude toward an inner circumferential side of a radial direction of the output shaft to be opposed to the rotor. The protruding cores are arranged in the axial direction and arranged in the circumferential direction. The protruding cores arranged in the circumferential direction are displaced in the axial direction so as to form a circumferential line of arrangement that is skewed relative to a direction in which the rotor makes the rotary motion.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a cross-sectional view of a linear-rotary actuator according to an embodiment;

FIG. 2 is an enlarged view of essential parts illustrated in FIG. 1;

FIG. 3 is a cross-sectional view of a rotor and a stator;

FIG. 4 is a perspective view of the rotor;

FIG. 5 is a side view of the rotor;

FIG. 6A is a cross-sectional view of the rotor;

FIG. 6B is a cross-sectional view of the rotor;

FIG. 7 is a perspective view of a core of the stator;

FIG. 8 is a development view of the stator;

FIG. 9 is a development view of the stator;

FIG. 10 is a cross-sectional view of a linear-rotary actuator according to another embodiment;

FIG. 11 is a perspective view of a core of a stator;

FIG. 12 is a development view of the stator; and

FIG. 13 is a cross-sectional view of a linear-rotary actuator according to still another embodiment.

### DESCRIPTION OF THE EMBODIMENTS

The embodiments will now be described with reference to the accompanying drawings, wherein like reference numerals designate corresponding or identical elements throughout the various drawings.

### First Embodiment

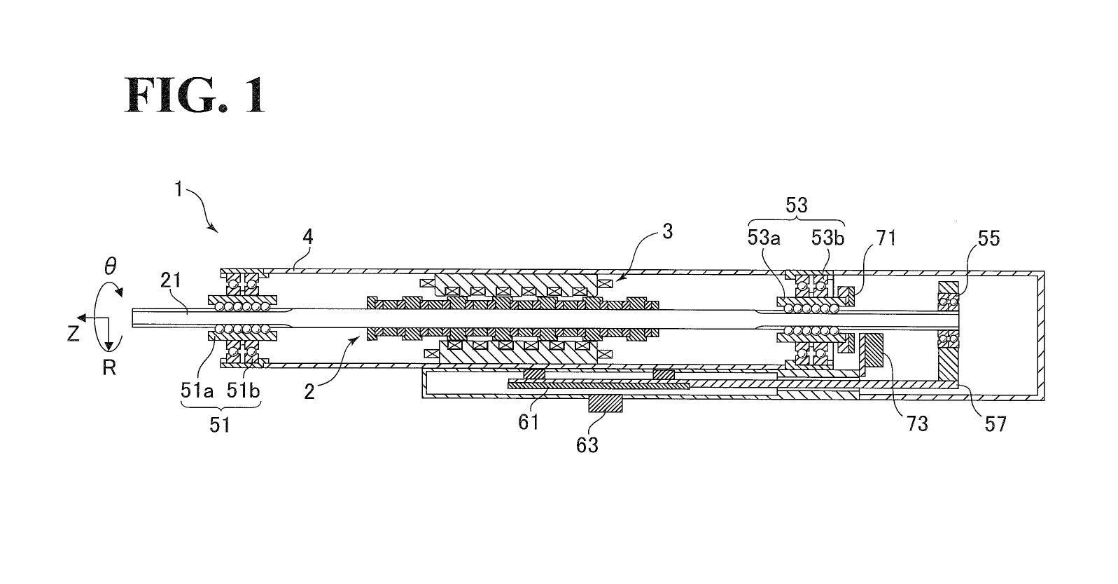

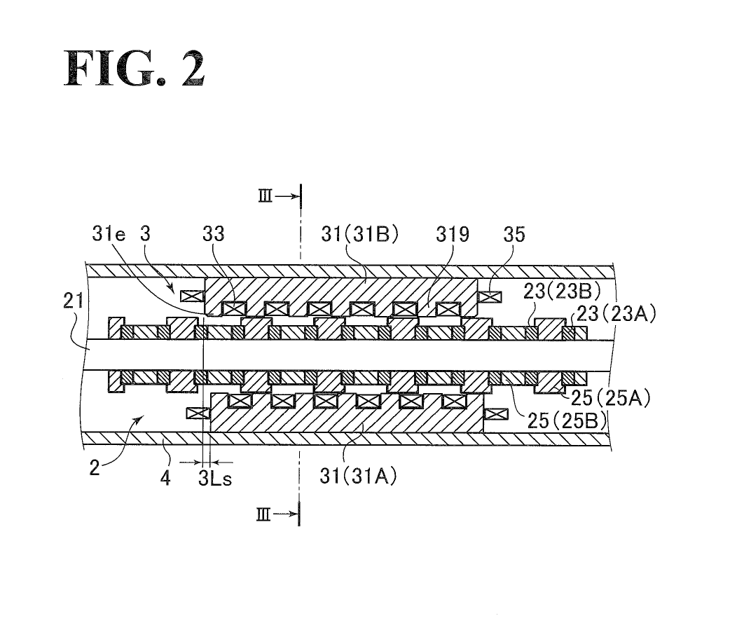

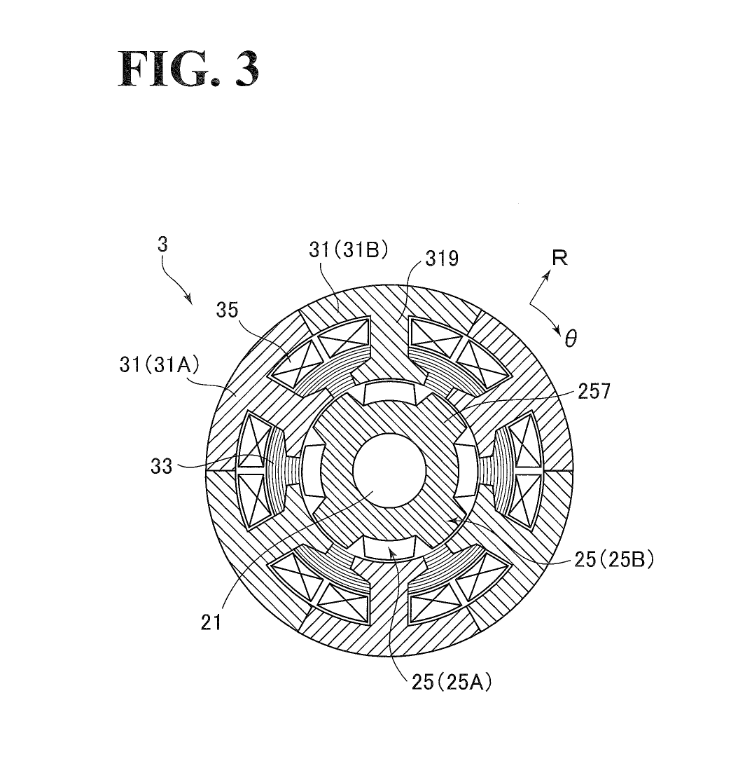

FIG. 1 is a cross-sectional view of a linear-rotary actuator 1 according to a first embodiment, taken along the axis of an output shaft 21. FIG. 2 is an enlarged view of essential parts, including a rotor 2 and a stator 3, of the linear-rotary actuator 1 illustrated in FIG. 1. FIG. 3 is a cross-sectional view of the rotor 2 and the stator 3, taken along the line of FIG. 2. In FIGS. 1 through 3, direction Z is the axial direction of the output shaft 21 and is a direction in which the rotor 2 moves linearly. Direction θ is the circumferential direction of the output shaft 21 and is a direction in which the rotor 2 rotates. Direction R is the radial direction of the output shaft 21.

As illustrated in FIG. 1, the linear-rotary actuator 1 includes the rotor 2 and the stator 3. The rotor 2 and the stator 3 are accommodated in a cylindrical housing 4. The rotor 2 includes the output shaft 21 and is supported by bearing units 51 and 53 to make a linear motion in direction Z and a rotary motion in direction θ relative to the housing 4. The bearing units 51 and 53 respectively include ball splines 51a and 53a and bearings 51b and 53b. A preferable example of the material of the output shaft 21 is a non-magnetic material. It is also possible, however, to use a ferromagnetic material. The stator 3 is secured on the inner circumferential surface of the housing 4, and surrounds the rotor 2.

One end of the output shaft 21 extends out of the housing 4. An atm 57 is attached to another end of the output shaft 21 through a bearing 55 and extends in direction Z. A linear scale 61 is attached to the arm 57. Together with a linear sensor 63, the linear scale 61 is used to detect the position of the output shaft 21 in direction Z. A disk-shaped permanent magnet 71 is attached to the ball spline 53a. The permanent magnet 71 and a magnetic detection element 73 constitute the magnetic encoder to detect the rotation angle of the output shaft 21 in direction θ. An optical rotary encoder may also be used.

As illustrated in FIGS. 2 and 3, the rotor 2 includes a plurality of permanent magnets 23 and a plurality of yokes 25. The permanent magnets 23 and the yokes 25 alternate with each other in direction Z. The permanent magnets 23 and the yokes 25 have annular shapes and are fitted around the output shaft 21. The permanent magnets 23 and the yokes 25 are in contact with each other and secured on the output shaft 21.

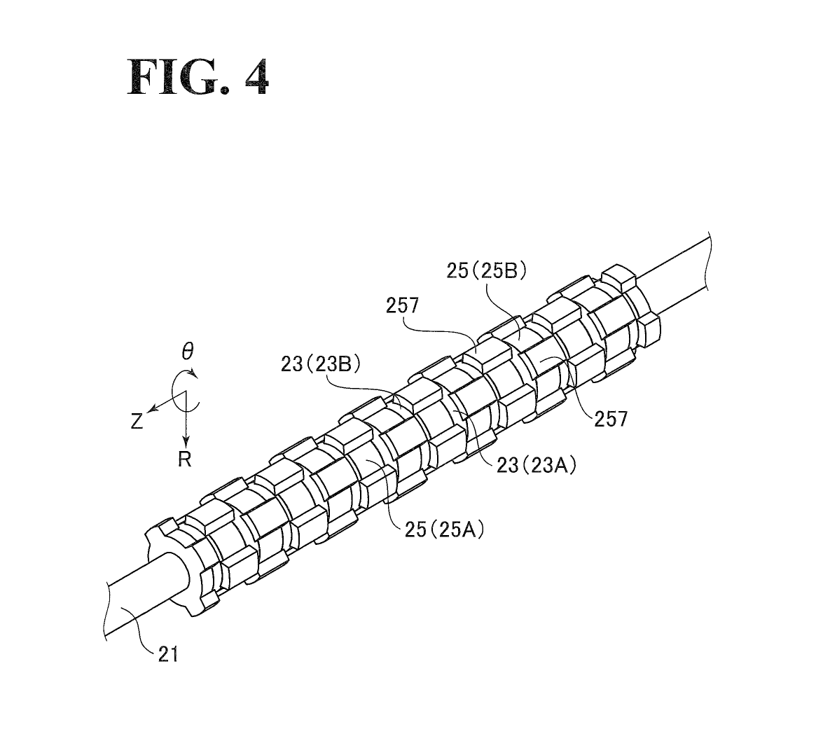

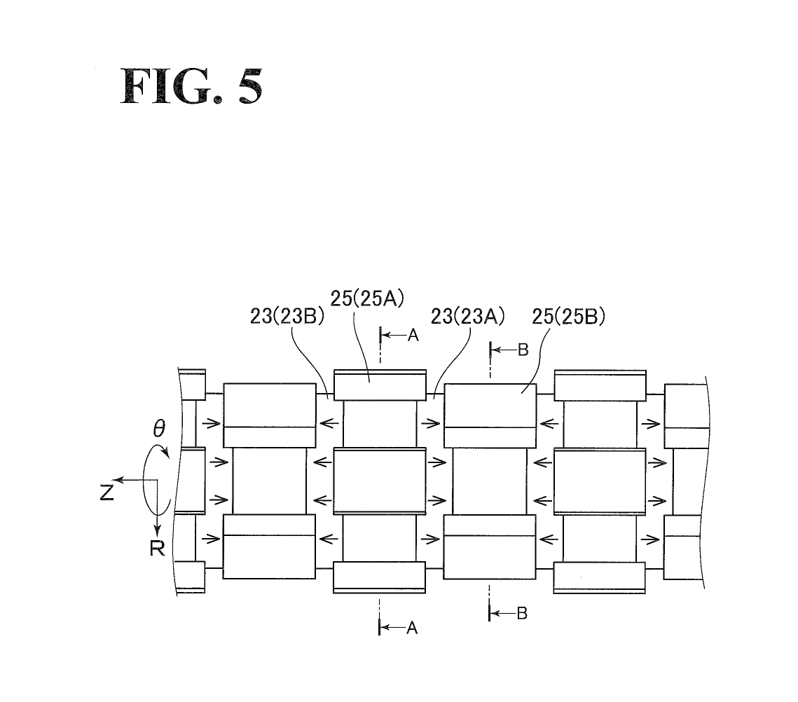

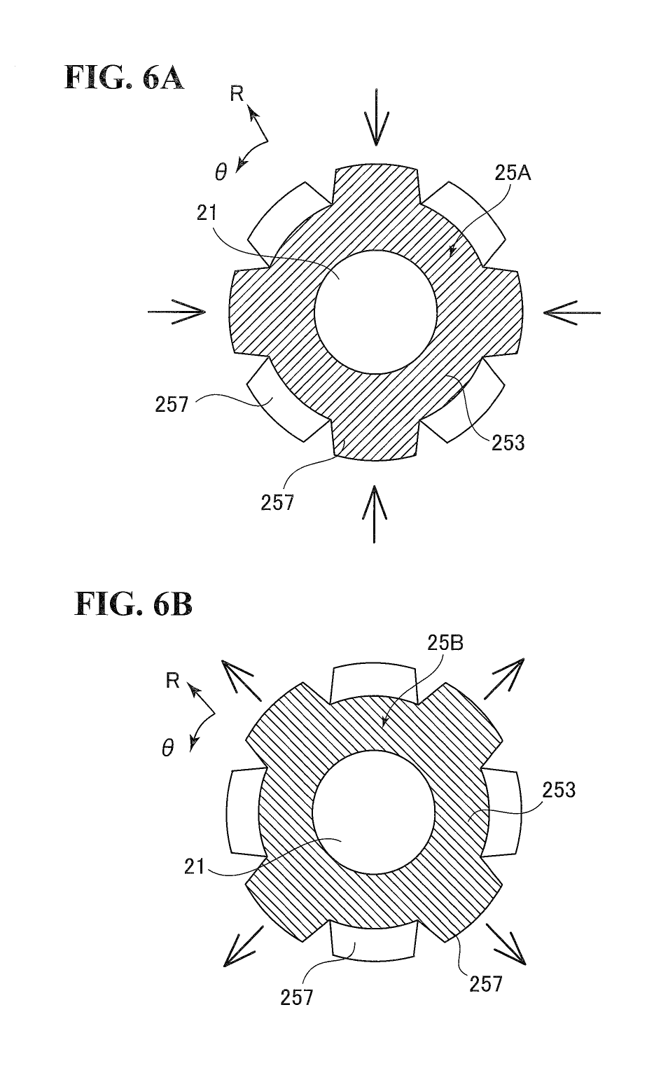

FIGS. 4 and 5 are respectively a perspective view and a side view of the rotor 2. In FIG. 5, the arrows on the permanent magnets 23 indicate directions of magnetization from the S pole to the N pole. FIG. 6A is a cross-sectional view of the rotor 2 taken along the line A-A of FIG. 5. FIG. 6B is a cross-sectional view of the rotor 2 taken along the line B-B of FIG. 5. In FIGS. 6A and 6B, the arrows around protrusions 257 of the yokes 25 indicate directions of magnetization from the N pole to the S pole.

The rotor 2 includes the plurality of permanent magnets 23 and the plurality of yokes 25. The plurality of permanent magnets 23 alternate with the plurality of yokes 25 in direction Z. The plurality of permanent magnets 23 include pettnanent magnets 23A and permanent magnets 23B. The permanent magnet 23A has its N pole on one side of direction Z. The permanent magnet 23B has its N pole on the other side of direction Z. The permanent magnet 23A and the permanent magnet 23B alternate with each other in direction Z. The plurality of yokes 25 include yokes 25A and yokes 25B. The yoke 25A is interposed between the S poles of the permanent magnets 23. The yoke 25B is interposed between the N poles of the permanent magnets 23. The yoke 25A and the yoke 25B alternate with each other in direction Z.

Each of the yokes 25 includes a plurality of protrusions 257. The protrusions 257 protrude from an annular portion 253 toward the outer circumferential side of direction R and are arranged in direction θ. The protrusions 257 are also referred to as teeth. The protrusions 257 of the yoke 25A, which is interposed between the S poles of the permanent magnets 23, are the S pole portions, while the protrusions 257 of the yoke 25B, which is interposed between the N poles of the permanent magnets 23, are the N pole portions. In other words, the outer circumferential side of the protrusions 257 of the yokes 25A in direction R is the S pole, while the outer circumferential side of the protrusions 257 of the yokes 25B in direction R is the N pole.

As seen in direction Z, the protrusions 257 (S pole portions) of the yokes 25A and the protrusions 257 (N pole portions) of the yokes 25B alternate with each other in direction θ. In the example illustrated in FIGS. 5 to 7A, each of the yokes 25A and 25B includes four protrusions 257 at intervals of 90 degrees. As seen in direction Z, eight protrusions 257 are arranged in direction θ at intervals of 45 degrees. As seen in direction θ, the protrusions 257 (S pole portions) of the yokes 25A and the protrusions 257 (N pole portions) of the yokes 25B alternate with each other in direction Z.

Referring back to FIGS. 2 and 3, the stator 3 includes linear motion windings 33 and rotary motion windings 35, which are wound around cores 31. The linear motion windings 33 and the rotary motion windings 35 are arranged concentrically around the output shaft 21 and overlap each other in direction R. The linear motion windings 33 are wound in direction θ to surround the rotor 2. Upon supply of current, the linear motion windings 33 generate a magnetic field to cause the rotor 2 to make a linear motion. The rotary motion windings 35 are wound in direction Z. Upon supply of current, the rotary motion windings 35 generate a magnetic field to cause the rotor 2 to make a rotary motion.

The stator 3 includes a plurality of cores 31 arranged in direction θ. The plurality of cores 31 constitute a cylindrical assembly surrounding the rotor 2. Each of the cores 31 includes a plurality of protruding cores 319, which protrude toward the inner circumferential side of direction R to be opposed to the rotor 2. The protruding cores 319 are also referred to as teeth. The protruding cores 319 are arranged in direction Z and in direction θ. In the example illustrated in FIGS. 2 and 3, seven protruding cores 319 are arranged in direction Z, and six protruding cores 319 are arranged in direction θ.

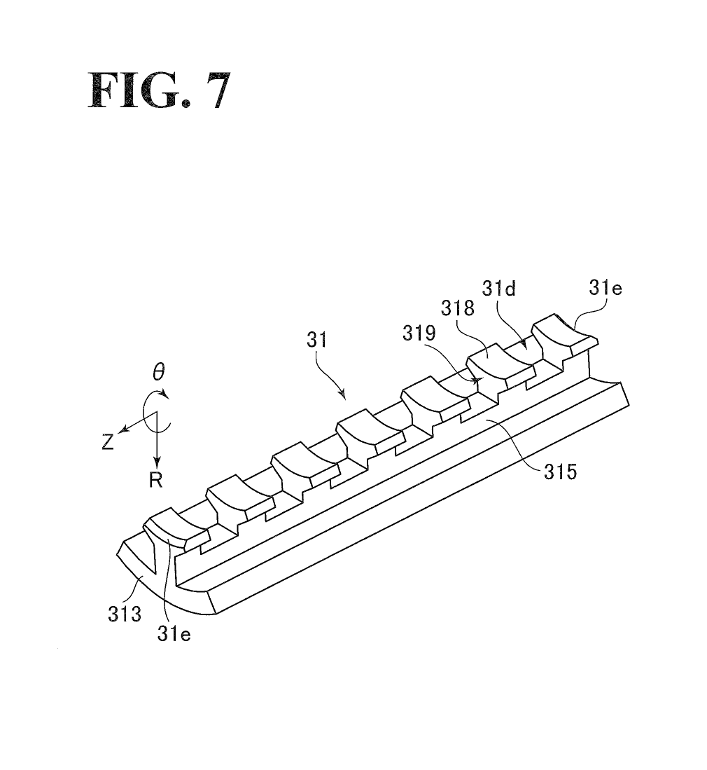

A specific configuration of the stator 3 is illustrated in FIG. 7. The stator 3 includes a wall 313, a rib 315, and the plurality of protruding cores 319. The wall 313 is curved along the inner circumferential surface of the housing 4. The rib 315 protrudes from the center of the wall 313 in direction θ toward the inner circumferential side of direction R. The plurality of protruding cores 319 protrude from the rib 315 toward the inner circumferential side of direction R. Each of the protruding cores 319 includes a distal end portion 318. The distal end portion 318 expands in direction θ.

The rotary motion winding 35 is repeatedly wound in direction Z to surround the rib 315. With the rotary motion windings 35 wound around the ribs 315, the cores 31 are accommodated in the housing 4 and assembled into a cylindrical shape. Each linear motion winding 33 is wound in direction θ across the plurality of cores 31, which are assembled in the cylindrical shape, in such a manner that the linear motion winding 33 is accommodated in a groove 31d between the protruding cores 319 adjacent to each other in direction Z.

Conventional linear-rotary actuators provided with cores involve cogging torque and cogging thrust.

In this embodiment, in order to minimize both cogging torque and cogging thrust, the protruding cores 319 arranged in direction θ are displaced in direction Z to form a skewed circumferential line.

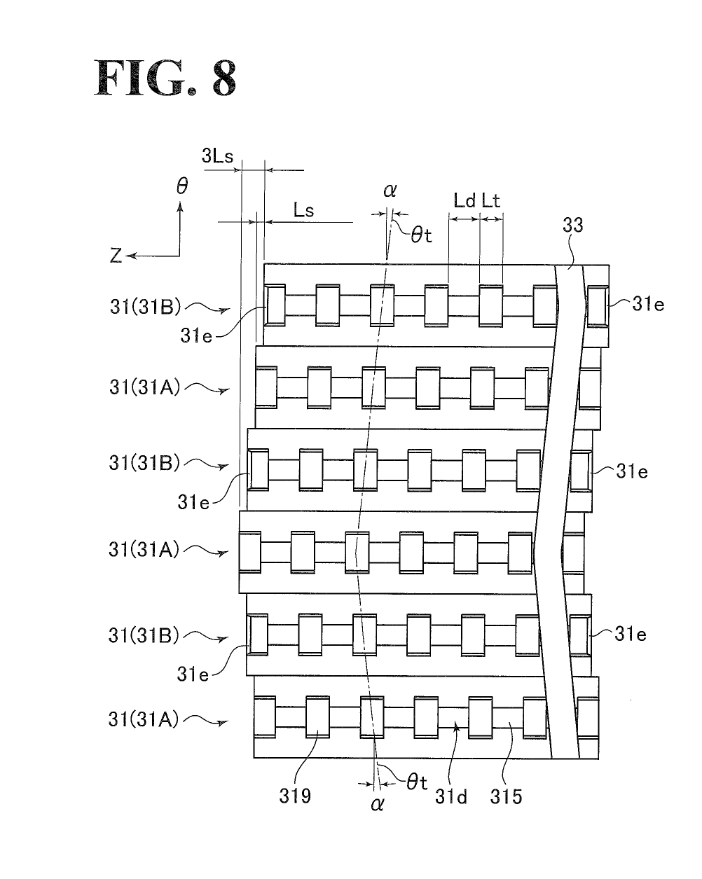

FIG. 8 is a development view of the stator 3, in which the stator 3 is developed along a line in direction θ. FIG. 8 illustrates a state in which the linear motion winding 33 is disposed in one of grooves 31d, each of which is disposed at an end of each of the cores 31 in direction Z.

As illustrated in FIG. 8, the protruding cores 319 are arranged in direction θ, and gradually displaced in direction Z as their arrangement proceeds in direction θ. The protruding cores 319 arranged in direction θ form a circumferential line of arrangement oriented in direction θt. Direction θt is at an angle (skewed) relative to the direction in which the rotor 2 makes its rotary motion (that is, relative to direction θ). A non-limiting example of the angle, a, of direction θt relative to direction θ is from 1 degree to 10 degrees. In accordance with the angle of direction θt, the linear motion windings 33 are skewed relative to direction θ.

Specifically, among the protruding cores 319 arranged in direction 8, those protruding cores 319 arranged over a semicircular range of the stator 3 form a first part of the circumferential line of arrangement. The first part of the circumferential line of arrangement is in direction θt that is skewed toward one side of direction Z at an angle of a. Also among the protruding cores 319 arranged in direction θ, those protruding cores 319 arranged over another semicircular range of the stator 3 form a second part of the circumferential line of arrangement. The second part of the circumferential line of arrangement is in direction θt that is skewed toward the other side of direction Z at an angle of a. That is, the protruding cores 319 arranged in direction θ are gradually displaced toward one side of direction Z as their arrangement proceeds to approximately the middle of direction 8, and gradually displaced toward the other side of direction Z as their arrangement is past approximately the middle of direction θ

In FIG. 8, dimension Lt is the length of the protruding core 319 in direction Z. Specifically, dimension Lt is the length, in direction Z, of the rectangular surface of the protruding core 319 that is opposed to the rotor 2. Dimension Ld is the length of the groove 31d in direction Z, that is, the interval between two adjacent protruding cores 319 in direction Z. Dimension Ls is the displacement difference in direction Z between adjacent protruding cores 319 arranged in direction θ. Dimension 3Ls is the maximum displacement difference in direction Z between the protruding cores 319 arranged in direction θ (see FIG. 2 as well). In a non-limiting example, the maximum displacement difference 3Ls is smaller than the interval Ld between two adjacent protruding cores 319.

Also in order to minimize both cogging torque and cogging thrust, in this embodiment, some protruding cores 319 among the plurality of protruding cores 319 arranged in direction θ are provided with chamfered portions extending in direction θ.

Specifically, as illustrated in FIG. 7, among the protruding cores 319 arranged in direction Z, the axially outermost protruding cores 319 each have a chamfered portion 31e on an outer edge of the axially outermost protruding core 319 in direction Z. The chamfered portion 31e is formed by cutting the corner of one of the edges defining the rectangular surface of the protruding core 319 that is opposed to the rotor 2. Forming the chamfered portions 31e in this manner minimizes the cogging thrust occurring between the rotor 2 and the stator 3.

As illustrated in FIG. 2, the range in direction Z over which the protruding cores 319 are arranged is shorter than the range in direction Z over which the permanent magnets 23 and the yokes 25 are arranged. In view of this, the outermost protruding cores 319 in direction Z are each provided with the chamfered portion 31e on the outer side of the outermost protruding core 319 in direction Z. This configuration eliminates or minimizes the influence of magnetic flux that is outer in direction Z than the chamfered portions 31e. This ensures effectiveness in minimizing the cogging thrust.

As illustrated in FIG. 8, the plurality of cores 31 include cores 31A and cores 31B. No chamfered portions 31e are formed on the protruding cores 319 of the core 31A. Chamfered portions 31e are formed on some of the protruding cores 319 of the core 31B. Specifically, the cores 31A and the cores 31B alternate with each other in direction θ. In other words, a protruding core 319 with a chamfered portion 31e alternates with a protruding core 319 without a chamfered portion 31e in direction θ. This configuration minimizes the cogging torque occurring between the rotor 2 and the stator 3.

In the example illustrated in FIG. 8, the cores 31A and the cores 31B alternate with each other in direction θ. This configuration, however, should not be construed in a limiting sense. Another possible example is that the cores 31B are disposed on an every-third-rotation basis in direction θ. In the example illustrated in FIG. 8, two chamfered portions 31e are level with each other in direction θ, that is, there is a chamfered portion 31e on one end in direction Z and another chamfered portion 31e on the opposite end in direction Z. This configuration, however, should not be construed in a limiting sense. These chamfered portions 31e may not necessarily be level with each other in direction θ. In a non-limiting embodiment, in order to minimize both cogging torque and cogging thrust, at least one chamfered portion 31e is formed on the outermost protruding core 319 in direction Z, among the protruding cores 319 that are arranged in direction θ and that form a circumferential line skewed relative to direction θ.

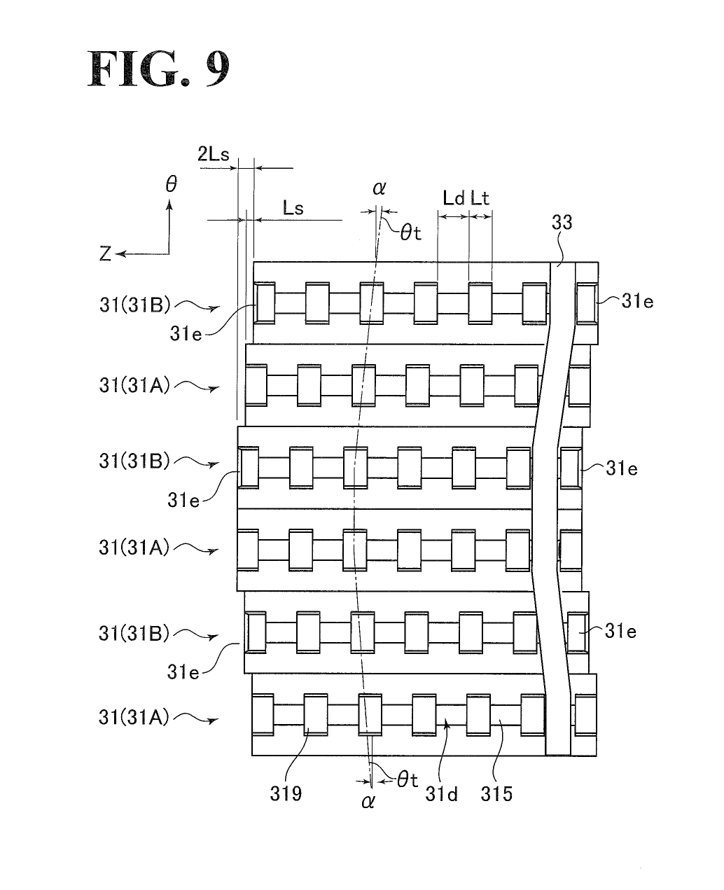

The skewed arrangement illustrated in FIG. 8 is that the protruding cores 319 arranged in direction θ are displaced in direction Z. This configuration, however, should not be construed in a limiting sense. Another possible example is illustrated in FIG. 9, where the protruding cores 319 arranged in direction θ are displaced in pairs in direction Z. Specifically, the two adjacent protruding cores 319 displaced farthest toward one side of direction Z are opposed across the shaft to the two adjacent protruding cores 319 displaced farthest toward the other side of direction Z. The remaining protruding cores 319 between the four protruding cores 319 are displaced from the four protruding cores 319 by a displacement difference of Ls in direction Z. In this case, there is a maximum displacement difference of 2Ls in direction Z between the protruding cores 319 arranged in direction θ.

### Second Embodiment

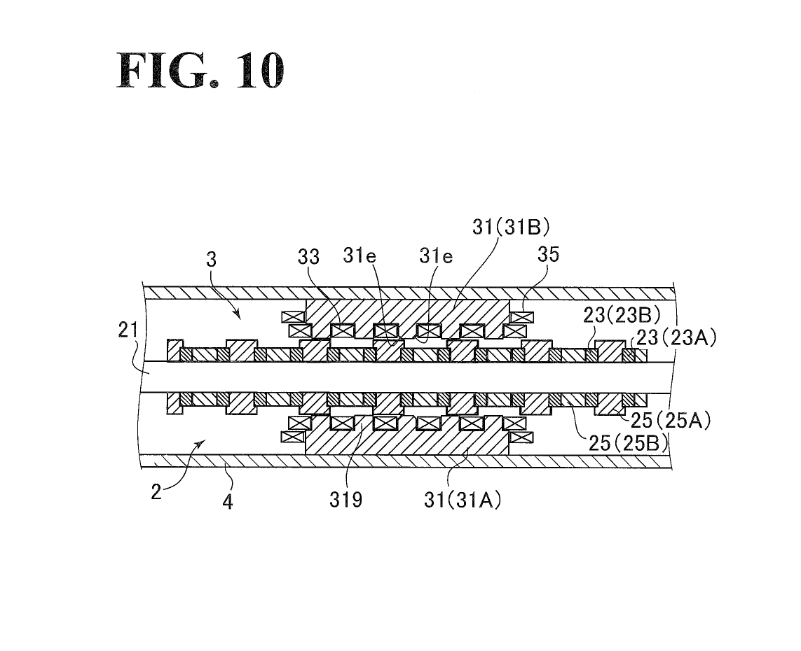

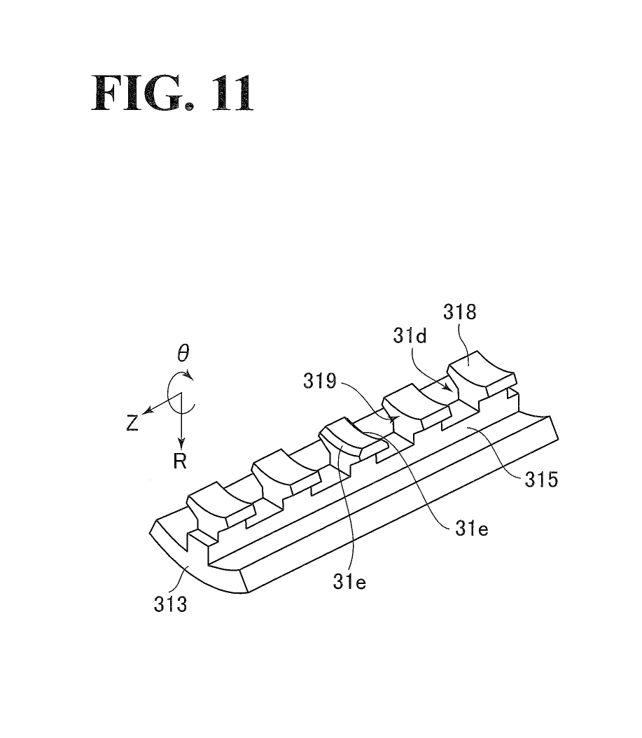

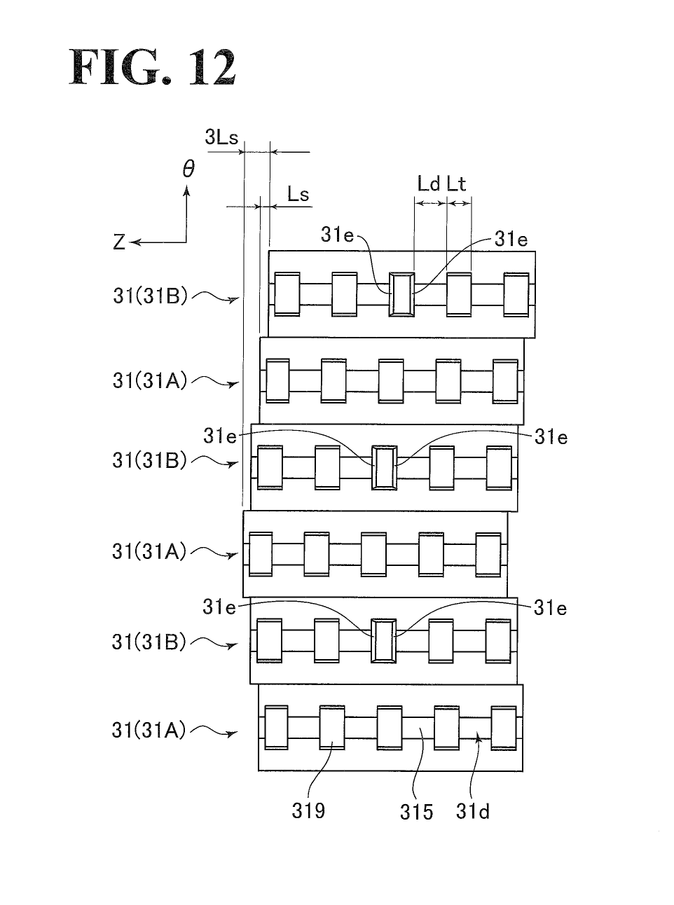

FIG. 10 is an enlarged cross-sectional view of essential parts, including a rotor 2 and a stator 3, of a linear-rotary actuator 1 according to a second embodiment. FIG. 11 is a perspective view of a core 31 of the stator 3. FIG. 12 is a development view of the stator 3, in which the stator 3 is developed along a line in direction θ. Like reference numerals designate corresponding or identical elements throughout this and above embodiments, and these elements will not be elaborated here.

In this embodiment, among the protruding cores 319 arranged in direction Z, an axially inner protruding core 319 that is inner in direction Z than the outermost protruding cores 319 in direction Z is provided with chamfered portions 31e. The chamfered portions 31e are formed on one edge and another edge of the axially inner protruding core 319 in direction Z. In the example illustrated in FIGS. 10 to 12, each core 31 includes five protruding cores 319 arranged in direction Z. Among the five protruding cores 319, the center protruding core 319 in direction Z is provided with the chamfered portions 31e. Forming the chamfered portions 31e in this manner minimizes the cogging thrust occurring between the rotor 2 and the stator 3.

In this embodiment as well, a protruding core 319 with chamfered portions 31e alternates with a protruding core 319 without chamfered portions 31e. This configuration minimizes the cogging torque occurring between the rotor 2 and the stator 3.

### Third Embodiment

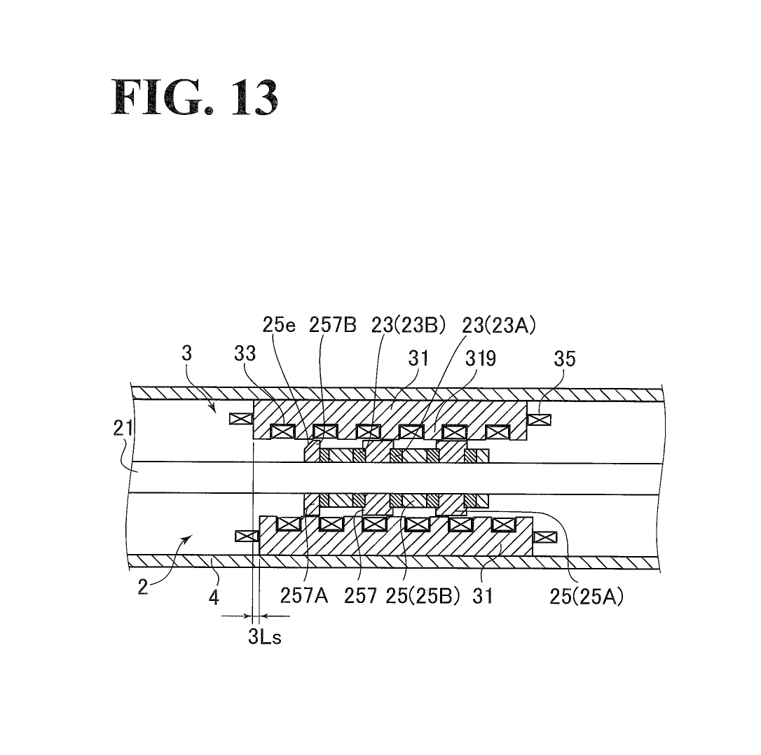

FIG. 13 is an enlarged cross-sectional view of essential parts, including a rotor 2 and a stator 3, of a linear-rotary actuator 1 according to a third embodiment. Like reference numerals designate corresponding or identical elements throughout this and above embodiments, and these elements will not be elaborated here.

In this embodiment, in order to minimize both cogging torque and cogging thrust, some of the plurality of yokes 25 of the rotor 2 include chamfered protrusions 257 in direction θ. The chamfered portions are formed on edges of the protrusions 257 in direction θ.

Specifically, among the yokes 25 arranged in direction Z, the outermost yoke 25 in direction Z includes a protrusion 257 with a chamfered portion 25e on the protrusion 257. The chamfered portion 25e is formed on an outer edge of the protrusion 257 in direction Z. Forming the chamfered portion 25e in this manner minimizes the cogging thrust occurring between the rotor 2 and the stator 3.

The range in direction Z over which the permanent magnets 23 and the yokes 25 are arranged is shorter than the range in direction Z over which the protruding cores 319 are arranged. In view of this, the outermost yoke 25 in direction Z is provided with the chamfered portion 25e on the outer edge of the protrusion 257 in direction Z. This configuration eliminates or minimizes the influence of magnetic flux that is outer in direction Z than the chamfered portions 31e. This ensures effectiveness in minimizing the cogging thrust.

In a non-limiting embodiment, among the yokes 25 arranged in direction Z, an inner yoke 25 that is inner in direction Z than the outermost yokes 25 in direction Z may include a protrusion 257 with chamfered portions 25e on one edge and another edge of the protrusion 257 in direction Z. This configuration also minimizes the cogging thrust occurring between the rotor 2 and the stator 3.

The plurality of protrusions 257 formed on the yokes 25 include protrusions 257A and protrusions 257B. No chamfered portions 25e are formed on the protrusions 257A. Chamfered portions 25e are formed on the protrusions 257B. Specifically, the protrusions 257A, which have no chamfered portions 25e, alternate in direction θ with the protrusions 257B, which respectively have the chamfered portions 25e. This configuration minimizes the cogging torque occurring between the rotor 2 and the stator 3.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A linear-rotary actuator comprising:
a rotor comprising an output shaft, the rotor being configured to make a linear motion in an axial direction of the output shaft and make a rotary motion in a circumferential direction of the output shaft, the rotor comprising N pole portions and S pole portions alternating with each other in the axial direction as seen in the circumferential direction and alternating with each other in the circumferential direction as seen in the axial direction; and
a stator comprising:
a linear motion winding to generate a first magnetic field to cause the rotor to make the linear motion;
a rotary motion winding to generate a second magnetic field to cause the rotor to make the rotary motion; and
a plurality of protruding cores protruding toward an inner circumferential side of a radial direction of the output shaft to be opposed to the rotor, the protruding cores being arranged in the axial direction and in the circumferential direction, the protruding cores arranged in the circumferential direction being displaced in the axial direction so as to form a circumferential line of arrangement that is skewed relative to a direction in which the rotor makes the rotary motion.

2. The linear-rotary actuator according to claim 1,
wherein at least two protruding cores among the plurality of protruding cores arranged in the circumferential direction are displaced toward a first side of the axial direction so as to form a first part of the circumferential line of arrangement skewed relative to the direction in which the rotor makes the rotary motion, and
wherein a rest of the plurality of protruding cores, other than the at least two protruding cores, arranged in the circumferential direction are displaced toward a second side of the axial direction so as to form a second part of the circumferential line of arrangement skewed relative to the direction in which the rotor makes the rotary motion.

3. The linear-rotary actuator according to claim 2, wherein a maximum difference of displacement in the axial direction between the plurality of protruding cores arranged in the circumferential direction is smaller than an interval between two protruding cores among the plurality of protruding cores arranged in the axial direction.

4. The linear-rotary actuator according to claim 1, wherein at least one protruding core among the plurality of protruding cores arranged in the circumferential direction comprises a chamfered portion extending in the circumferential direction.

5. The linear-rotary actuator according to claim 4, wherein the at least one protruding core comprises an axially outermost protruding core among the plurality of protruding cores arranged in the axial direction, and the chamfered portion of the axially outermost protruding core is on an outer edge of the axially outermost protruding core in the axial direction.

6. The linear-rotary actuator according to claim 4, wherein the at least one protruding core comprises an axially inner protruding core that is among the plurality of protruding cores arranged in the axial direction and that is inner in the axial direction than an axially outermost protruding core among the plurality of protruding cores arranged in the axial direction, and the axially inner protruding core comprises chamfered portions on one edge and another edge of the axially inner protruding core in the axial direction.

7. The linear-rotary actuator according to claim 1,
wherein the N pole portions and the S pole portions protrude toward an outer circumferential side of the radial direction, and
wherein at least one N pole portion among the N pole portions and at least one S pole portion among the S pole portions each comprise a chamfered portion extending in the circumferential direction.
